(19) United States
(12) Patent Application Publication
(10) Pub. No.: US 2009/0077098 A1
(43) Pub. Date: Mar. 19, 2009

(54) DISTRIBUTION OF INFORMATION IN TELECOMMUNICATION SYSTEMS

(75) Inventors: Sami Leino, Turku (FI); Aarre Pohjavirta, Helsinki (FI)

Correspondence Address: BROOKS KUSHMAN P.C., 1000 TOWN CENTER, TWENTY-SECOND FLOOR, SOUTHFIELD, MI, 48075, US

(73) Assignee: SENDANDSEE OY, Espoo (FI)

(21) Appl. No.: 12/158,959

(22) PCT Filed: Dec. 21, 2006
(86) PCT No.: PCT/FI06/50574

§ 371 Date: Nov. 4, 2008

(30) Foreign Application Priority Data
Dec. 22, 2005 (FI) 20055693

(51) Int. Cl. G06F 17/30

(52) U.S. Cl. 707/10

(57) ABSTRACT

A solution for information distribution in a communication system. A service view comprises one or more pages, a page being a separate output item comprising a combina-tion of content data and page definition data such that the page definition data controls the format of the content data at outputting of the page. A server collects the content data of the one or more pages of a service views and packages the content data into a service package A page definition data is stored in the user terminal, and combined with the content data in the service package. All the pages of the service view may thereafter be viewed at the user terminal.

### FIELD OF THE INVENTION

The present invention relates to telecommunication systems, and particularly to a method, a communication system, a server, a user terminal, and a computer program product according to the preambles of the respective independent claims.

### BACKGROUND OF THE INVENTION

Telecommunication refers generally to exchange of information by electromagnetic signals. The elements of a telecommunication system comprise a transmitter that encodes a message into an electromagnetic signal, a receiver that is provided with a decoding mechanism that transforms the electromagnetic signal back into a message, and a medium that carries electromagnetic signals between transmitters and receivers.

Distribution of information in a telecommunication system is typically related to the use of media for transferring audio, video, or any other type of information to a user or to a number of users who are not expected to apply considerable post-production processing to the information, but essentially to consume it locally.

Telecommunication systems offer a number of various ways to distribute information in telecommunication systems depending, for example, on the accepted delay and level of interaction between the endpoints. Streaming services relate to essentially simultaneous transmission and usage of data where the use may begin even before all data is even transmitted to the receiver. The users typically appreciate streaming services, because the information is always current and readily available. On the other hand, implementation of streaming services heavily occupies the media and, for example, in mobile systems where radio the resource of the air interface is limited, other forms of distribution are typically preferred.

One such form is to maintain information in one or more centrally operated computers and make this information accessible via a network to the users of the telecommunication system. A widely accepted and utilized means of describing this kind of network services and modelling user processes of those services is the client-server architecture. The information to be distributed as part of the service is maintained in a server, essentially a computer that serves other computers that may access it using a telecommunication network. A client is a computer system or a process in a computer system, which may access the server and request the server to perform defined tasks. Pull services relate to implementations where a user terminal comprises a browser such that the user performs a request using a browser and directly obtains the results of the search. Push services relate to implementations where a service user's terminal equipment is sent information without a separate request for a single transmission.

The most well known prior art solutions for distribution of information comprise websites. A website refers to a collection of web pages, typically common to a particular domain name or sub-domain on the World Wide Web on the Internet. The pages of a website are accessible from a common root URL, and typically reside on the same physical server. A web page corresponds to a separately accessible information entity based on a hypertext markup language (HTML) file, and can be reproduced with the user's web browser. A web page can be either a single page, or a frameset made up of separate frames, where each frame contains an HTML page.

In the user terminal one web page at a time is displayed in a web browser window. There is no immediate correlation between the size of the web page and the web browser window in the user terminal. Actually, web pages are often taller than the browser window and therefore require vertical scrolling in the user terminal. On some occasions pages also have additional content on the right, which necessitates horizontal scrolling. Such pages are, however, less common, because most users find reading that requires simultaneous scrolling in two directions highly inconvenient. Moving from one page to another requires a new HTML file to be downloaded from the server or buffer memory in the user terminal.

In mobile communications, access between the server and the user terminal typically comprises transmission over the air interface, which imposes limitations to the bandwidth that is available for downloading the web page files. The mobile user terminal also needs to be compact in size such that the equipment can be conveniently carried around. A web browser specifically designed for use on a handheld device is usually called a microbrowser. Microbrowsers are optimised so as to display internet content most effectively for small screens on portable devices and have small file sizes to accommodate the low memory capacity and low-bandwidth of wireless hand-held devices. Essentially, microbrowsers are stripped-down web browsers and still follow the similar information retrieval mechanism that was disclosed above.

The problem associated with these prior art solutions relates to services where one or more pages create a uniform contentual entity. In prior art solutions linking of parts forming a content is implemented by automated cross-references to other documents called hyperlinks. Selecting a hyperlink causes the computer to display the linked document within a short period of time. However, when the quality of the network connection is low or only limited bandwidth is available, the period required for downloading the next page becomes longer. Additionally, the user experience of the service becomes susceptible to all the possible negative events possible during the repeated download proceudures. Such features make the use of service frustrating and tend to discourage users from utilizing the service.

A practical example of such use cases is publication of mobile news. Several content providers, for example, news agencies and broadcasting companies, provide an Internet news service. This is implemented as a dynamic website that comprises web pages with frequently changing information. Such websites are often complemented with a range of mobile pages that are optimized for download into a handheld device. When the web server receives a request for a given page, a corresponding page is generated in the server in direct response to the page request and delivered to the requesting user terminal. The service is typically initiated by retrieving the home page of the service in the user terminal. The home page comprises hypertext links that enable navigation from one page to another.

When operating over a slow connection, i.e. a narrow bandwidth modem or radio access network, the time required for the next page to download typically gets inconveniently long and the user moves on to other sites and services. Due to the vulnerable nature of the air interface the problems with several download instances are experienced very concretely in distribution of mobile news, in terms of broken connections, repeated reloading and prolonged downloading times in poorer coverage areas.

### BRIEF DESCRIPTION OF THE INVENTION

An object of the present invention is thus to provide solution to solve the above problem in distribution of information in telecommunication systems. The objects of the invention are achieved by a method and an arrangement, which are characterized by what is stated in the independent claims. The preferred embodiments of the invention are disclosed in the dependent claims.

The invention is based on the idea creating at least one service view that comprises definitions for one or more pages that create a uniform contentual entity of the service. The content data of the one or more pages is collected and packed into a downloadable service package. This service package is made accessible to the user terminals, preferably via any type of access network. A page represents here a separate output item that is formed as a combination of at least content data and definition data that controls the format of the content data at outputting of the page. In visual output, a page corresponds to an entity separately displayed in the browser window. The definition data of the service view is primarily stored in the user terminal, and when the user terminal receives the content data of the downloaded pages, the content data and the definition data are combined such that the uniform content entity of the service becomes comfortably browsable by typical scrolling operations of the display window.

An advantage of the solution according to the invention is that the user may access the uniform entity with one request procedure after which all the necessary information becomes readily available in the user terminal. Considerably large contentual entity may be quickly transferred, even over narrow bandwidth connections, since in most of the cases only the true payload needs to be transferred between the server and the user terminal. The dynamic nature of the distributed information is, however, by no means compromised, since the packing stage allows immediate update of any part of the information.

### BRIEF DESCRIPTION OF THE DRAWINGS

In the following the invention will be described in greater detail by means of preferred embodiments with reference to the attached [accompanying] drawings, in which

FIG. 1 illustrates the functional architecture of a telecommunication system;

FIG. 2 illustrates the logical elements for implementing the present embodiment;

FIG. 3 illustrates an example of a service view;

FIG. 4 illustrates an example of the functionality of an application server;

FIG. 5 illustrates a functional description of an application server;

FIG. 6 illustrates an example of the functionality of user equipment;

FIG. 7 shows a functional description of user equipment;

FIG. 8 illustrates functionality of the application service in implementation of a pull type of news service of FIG. 3.

### DETAILED DESCRIPTION OF THE INVENTION

The present invention can be applied to any telecommunication system where a user terminal may utilize a network or a combination of interconnected networks to access information maintained in another network element. Such telecommunications systems comprise, for example, mobile communication systems like a Universal Mobile Telecommunications System (UMTS), systems corresponding to the Global System for Mobile Communications (GSM), like GSM 1800 and PCS (Personal Communication System), and any systems based thereon, for example GSM 2+ systems. Services of the GSM 2+ phase comprise, among others, a General Packet Radio Service (GPRS), Enhanced Data rates for Global Evolution (EDGE) and Customized Applications for Mobile network Enhanced Logic (CAMEL). The invention is also applicable to any fixed telecommunication systems capable of fulfilling the above requirement.

The solution according to the present invention is illustrated using a mobile communications system as an example. A mobile communications system refers generally to any telecommunications system wherein the access point (typically wireless access) to the system may change when users are moving within the service area of the system. Access in this context is interpreted as a mechanism that connects a user equipment to an access point for communication between the user equipment and the access point. The access point may be, for example, a network node or another user equipment. It should be noted, however, that the scope of protection covers systems comprising mobile networks, fixed networks, and combinations of each.

A typical mobile communications system is a Public Land Mobile Network (PLMN). The mobile communications network is often an access network providing a user with wireless access to external networks, hosts, or services offered by specific service providers.

Mobile communication systems are developing continuously and one of the main objectives has been to prepare a general infrastructure that is able to implement existing and also future services. In the following, an embodiment of the invention is described by means of a third generation (3G) mobile communication system, but the solution is applicable to various systems and the scope of protection should not be interpreted limited by the terms and concepts specific for this embodiment.

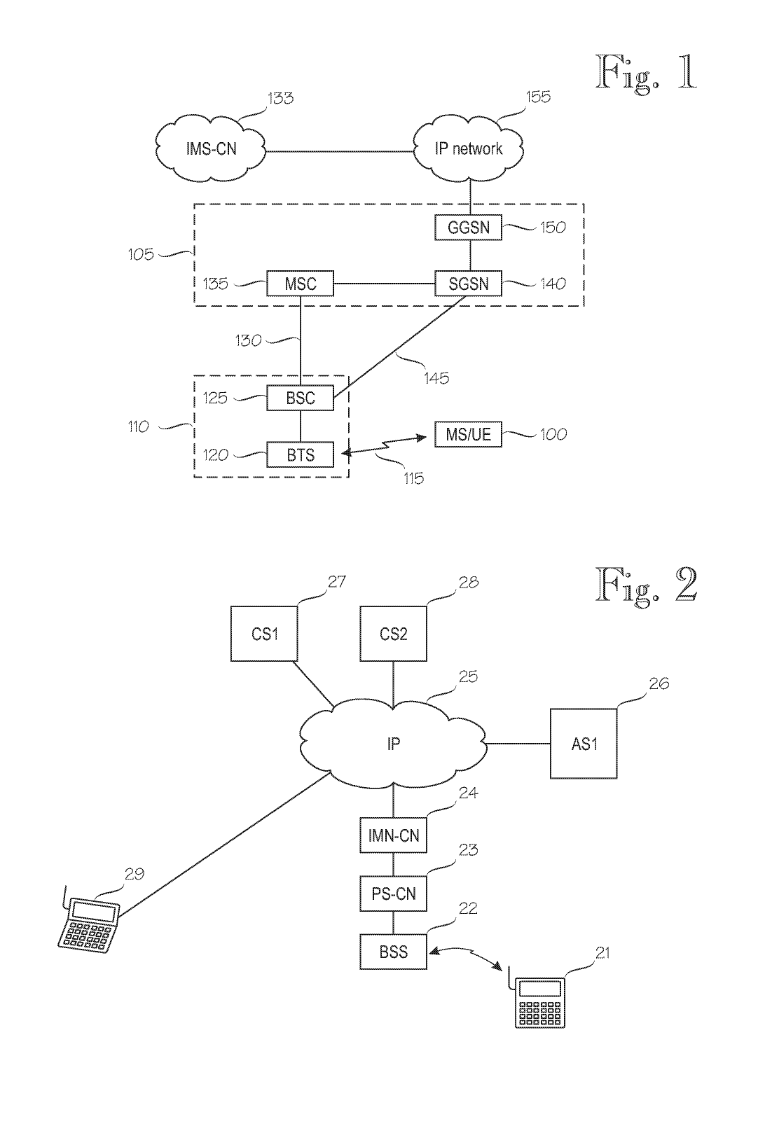

The block chart of FIG. 1 illustrates the functional architecture of a telecommunication system. The first leg of the system illustrates a mode of operation of the mobile station (MS) 100 connected to the Core Network (CN) 105 via General Packet Radio Service (GPRS) system, the GSM system (Global System for Mobile communications) acting as a Radio Access Network (RAN). Generally, the basic structure of a GSM network comprises two parts: a base station system (BSS) 110 and a network subsystem (NSS). The GSM BSS communicates with mobile stations (MS) 100 via radio connections over a radio interface Um 115. In the base station system BSS 110 each cell is served by a base transceiver station (BTS) 120. The base station 120 is connected to a base station controller (BSC) 125, which controls the radio frequencies and channels used by the base station. The base station controller BSC 125 is connected over an A-interface 130 to a mobile switching centre (MSC) 135, i.e. as a part of GSM NSS to the core network NC 105 of the system.

The Serving GPRS Support Node (SGSN) 140 keeps track of the location of individual mobile stations and performs security functions and access control. The SGSN 140 is connected to the GSM base station system through the Gb interface 145. The Gateway GPRS Support Node (GGSN) 150 provides interworking with packet data networks, and is connected with SGSNs via an IP-based packet domain PLMN backbone network.

In order to use GPRS services, an MS shall first make its presence known to the network by performing a GPRS attach. This makes the MS available for SMS over GPRS, paging via the SGSN, and notification of incoming packet data. In order to send and receive packet data by means of GPRS services, the MS shall activate the Packet Data Protocol context that it wants to use. This operation makes the MS known in the corresponding GGSN, and interworking with data networks can commence.

It should be noted that only elements and units essential for understanding the invention are illustrated in FIG. 1. For a person skilled in the art it is clear that a communication system typically comprises a plurality of elements that are not shown in FIG. 1.

The first access type in the present embodiment is described by means of access to IP multimedia subsystem IMS. The IP multimedia subsystem comprises CN elements for provision of multimedia services. The IP multimedia subsystem IMS 133 utilizes the PS domain to transport multimedia signaling and bearer traffic. The IP Multimedia Core Network subsystem (IM CN subsystem) comprises core network elements for provision of IP multimedia services like audio, video, text, chat, etc. and a combination of them delivered over the PS domain. The session flow procedures of IP CN subsystem session are controlled by a call session control function (CSCF), which is divided into several different roles. The Proxy-CSCF (P-CSCF) is substantially the first contact point within the IP CN subsystem. The P-CSCF behaves like a proxy and thus accepts requests and services them internally or forwards them on. Interrogating-CSCF (I-CSCF) is the contact point within an operator's network for all connections destined to a user of that network operator. The Serving-CSCF (S-CSCF) performs the session control services for the user equipment. It maintains a session state as needed by the network operator for support of the services. The S-CSCF usually contains a subscriber database to which required subscription data is downloaded when the user terminal registers to the S-CSCF. The roles and operation of these IMS call session control functions in implementing IMS sessions are described in public telecommunication standards and as such familiar to a person skilled in the art.

The user equipment UE can be a simplified terminal for speech only or it can be a terminal for diverse services acting as a service platform and supporting the loading and execution of various functions related to the services. User equipment UE comprises actual mobile equipment ME and a detachably connected identification card USIM, also called a subscriber identity module. In this context, the user equipment UE generally refers to the entity formed by the subscriber identity module and the actual mobile equipment. The subscriber identity module USIM is a smart card that substantially holds the subscriber identity, performs authentication algorithms, and stores authentication and encryption keys and other subscription information that is needed at the mobile station. The mobile equipment ME may be any equipment capable of communicating in a mobile communication system or a combination of several pieces of equipment, for instance a multimedia computer to which a card phone has been connected to provide a mobile connection.

The solution of the present invention improves distribution of information in a telecommunication system. Distribution of information is in the following embodied by means of a mobile news service, but for a person skilled in the art it is clear that the invention may relate to several other types of information distribution services that are available to non-mobile and mobile users. Such services comprise, for example, basic or supplementary services of the communications system, services accessible through the communications system or communication services eventually independent of the communications system.

In the first embodiment, a news service comprising a number of pages in form of a contentual uniform service view is disclosed. The block chart of FIG. 2 illustrates the logical elements for implementing the present embodiment. For clarity, only elements that are essential for understanding the invention are shown. For a person skilled in the art it is also clear that in different systems the logical elements may be divided or combined into different physical elements.

Based on the elements shown in FIG. 1, FIG. 2 shows a configuration that through a base station subsystem (BSS) 22, a packet-switched core network (PS-CN) 23, an IP multimedia subsystem (IMS-CN) 24, and an IP network 25 provides a connection, preferably a packet-switched connection between a application server (AS) 26 and a user equipment (UE) 21. In the present embodiment, the application server AS 26 is a publication server that represents a primary point of contact to the user equipment UE 21. The application server AS 26 is connected through the IP network 25 to a first content source CS1 27 that in this example represents the actual provider of the news service, and a second content source CS3 28 that represents any external content sources utilized in implementing the news service. For a person skilled in the art it is clear that the IP network 25 herein represents a variety of different types of network configurations, and the solution is correspondingly applicable to a variety fixed user equipment 29 for which an access to the application server AS may be arranged.

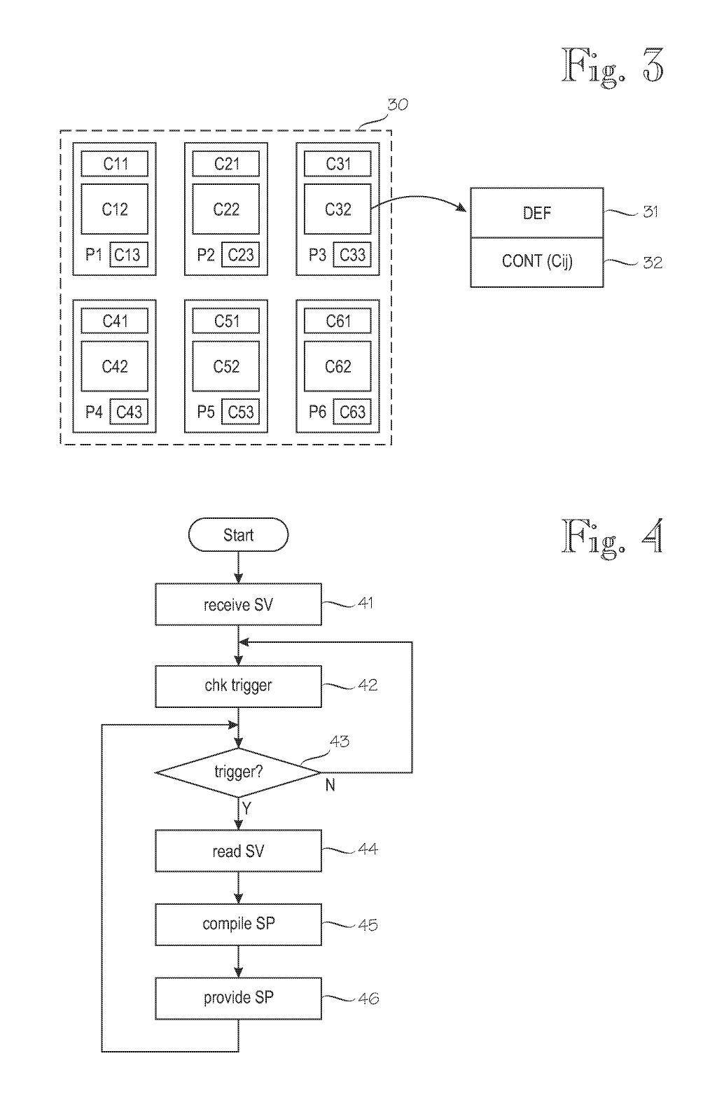

In establishing the service the operator of the service, here the first content source CS1 creates a service view. FIG. 3 illustrates an example of a service view associated with the present embodiment. The service view 30 corresponds to a contentual entity formed by a number of pages P1 to P6 that are to be made available to a user in the auspices of the service. In the prior art solutions such pages are of variable format, stored as separate files and made accessible to the users via the network. In the present invention, however, the pages made available by the service view have a common structural format part that is shared by all the pages P1 to P6 of the service. Thus the service view 30 establishes a structural definition DEF 31 that comprises elements f1, f2, . . . that control the common structural format part of the pages of the service. Such elements may control, for example, display characteristics, such as the color of the background, standard logos of the content provider, fonts. The service view 30 also establishes a content definition CONT 32 that comprises definitions for the content elements CONT c11, c12, c13, c21, c22, c23, etc. to be included in the pages of the service. A page P3 is thus a separate output item that may be created by combining the structural definition DEF 31 of the service view and content elements c31, c32, c33.

When the service view has been appropriately established by the service provider, it is transferred to the application server AS 26. Thereafter, when AS 26 receives from a user equipment UE 21 a request related to the service view, it initiates an editing procedure that collects and retrieves from the first content source CS1 and/or from any second content sources CS2 the content elements CONT (c11, c12, . . . , c63) of the service view, and packages them into a downloadable service package. The package is downloaded to the requesting UE 21.

When the service view has been appropriately established by the service provider, it may correspondingly transferred to a user equipment 21 that decides to subscribe the service. The structural definition DEF 31 is in the user equipment, and when a new service package is downloaded from AS 26, the content elements of the service package may be combined with the structural definition such that the one or more pages of the service may be output in UE21. The user receives with one download the relevant pages of the service, and may then quickly browse the whole content designed to be distributed through the service. The implementation of the invented solution in the elements of the configuration of FIG. 2 is disclosed in more detail below.

It should be noted that even though in the embodied implementation the operations of the various elements are discussed separately, it is clear that the ownership or operational responsibility is not relevant to the present invention. Correspondingly, even though each of the access server AS and the content sources CS1, CS2 are shown as one separate element their physical implementation is not relevant to the present invention. The elements may be implemented by only one physical element or the disclosed functionalities may be distributed to several physical elements, depending on the application at hand.

The flow chart of FIG. 4 illustrates an example of the functionality of an application server in view of the embodiment of the invention discussed in connection of FIG. 3. In step 41 the application server acting as a publication server receives information on a service view (SV) of a news service. This service view configures a news service that distributes news pages of the first content source CS1, here a daily magazine. The message may be received through the network from a daily magazine's server acting as a first content source CS1. Naturally the service view may alternatively be configured through the user interface of the application server. The service view comprises a definition for a group of content elements of pages P1 to P6 to be made available within the service view. A content element is advantageously defined as an identification of a content elements and an address of the resource files where the data of the content element is available for the application server. Advantageously, the service view also comprises a definition on the events that trigger the subsequent functionalities of the service. The reception of the service view initializes a new service and enables the invented operation of the application server.

For each service there is at least one, but typically more that one, condition that triggers generation of the downloadable service package in AS. A new package may be generated, for example, at predefined intervals according to a timer, in response to any new information received from the primary or secondary content source, or in response to a request from the user terminal. Several other triggering points may be utilized without deviating from the scope of protection for the present invention. In step 42 AS checks whether the triggering condition is met. If not, AS will standby and check the condition again after a defined interval. If the triggering condition is met, AS reads the service view (step 44) and begins to compile a downloadable service package.

The compilation step 45 comprises retrieval of the resource files referenced in the service view. The information may have been already fed by the content sources to the application server, and the retrieval can then be implemented by mere memory operation of the application server. The information may, however, also be maintained in an external content source and needs first to be retrieved to the application server through the network connection between the application server and the relevant content source. An advantageous method for referencing the information in the network is to use extensible markup language (XML), a general-purpose markup language that facilitates sharing of data across different systems, particularly systems connected via the Internet. XML manifests as text, interspersed with a markup that indicates separation into a hierarchy of character data, container-like elements, and attributes of those elements. Sharing of information by means of XML is generally known to a person skilled in the art, and will not be discussed in more detail herein.

The compilation step may also comprise inclusion of some additional attributes related to the communication between the application server and the user terminal. Such attributes may comprise information on the identity and/or timing of the package, some format commands for complementing or overriding the main structural definition of the service, for example.

After the compilation the exemplary data for a service package could be as follows:
<c11>
<c12>
<c13>
<c21>
<c22>
<c23>
<c31>
<. . . >
<c61>
<c62>
<c63>
<edition>
<options>
where
<cᵢⱼ> refer to content elements that may comprise various types of data, including text, pictures, voice, scripts, etc.
<edition> comprises information on the particular package, for example the date and time stamp, and
<options> comprises definitions for the option keys shown in the display. It should be noted that only the elements necessary for illustrating the present invention are disclosed. For a person skilled in the art it is clear that in true implementations, a package may comprise a number of definitions not shown or discussed here.

The final stage of the compilation step is compression. In compression, data is encoded into a compact form, by taking advantage of known characteristics of the data, in such a way that the original information can be recovered by decompression. Compression is an advantageous, but not mandatory procedure implemented in order to minimize the use of bandwidth in transmission to the user terminal. There exists a range of alternative compression methods available for a person skilled in the art, for example LZSS coding, LZW coding, Huffman coding, arithmetic coding etc.

After compilation the service package is made available for the user terminals of the service subscribers (step 46), the means of providing the information being dependent on the defined triggering condition. For example, in case the service package is compiled in response to a request from the user terminal, is may be sent directly to the requesting user terminal. Correspondingly, in case the service package is compiled in response to some other, typically network-based condition, the previously stored package in the application server is discarded and the new compiled package is provided for download in AS.

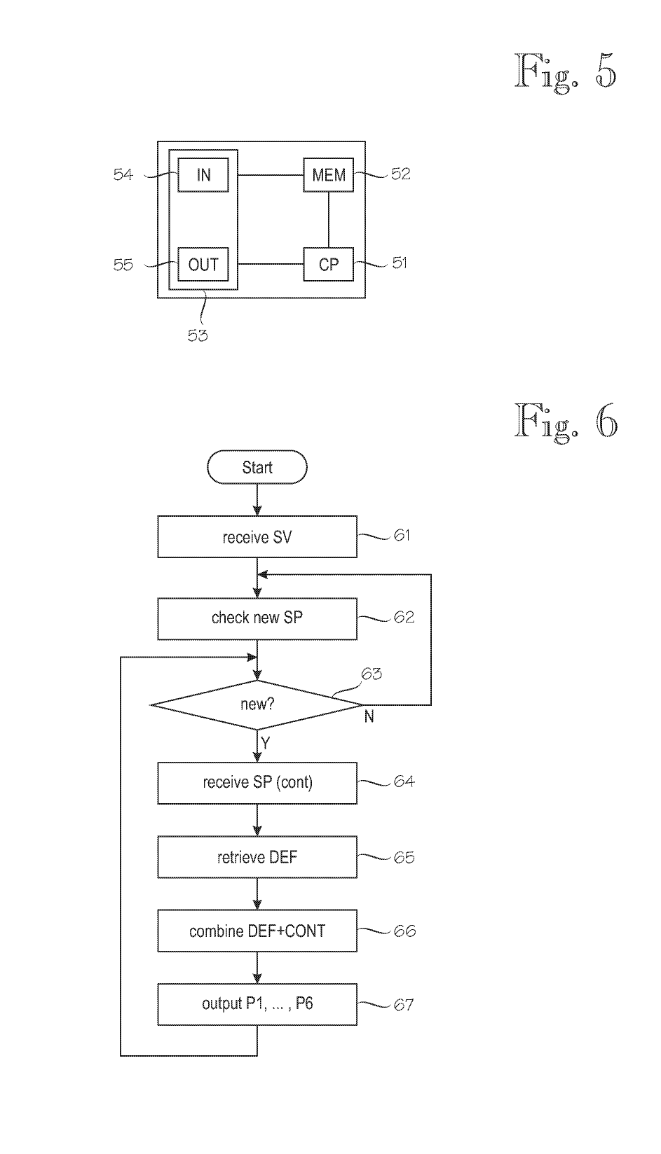

The implementation of the disclosed embodiment of the invention in the application server is illustrated by referring to FIG. 5 that comprises a functional description of an application server. The network node comprises processing means 51, an element that comprises an arithmetic logic unit, a number of special registers and control circuits. Connected to the processing means are memory means 52, a data medium where computer-readable data or programs or user data can be stored. The memory means typically comprise memory units that allow both reading and writing (RAM), and a memory whose contents can only be read (ROM). The unit also comprises an interface block 53 with input means 54 for inputting data for internal processing in the unit, and output means 55 for outputting data from the internal processes of the unit. Examples of said input means comprise a plug-in unit acting as a gateway for information delivered to its external connection points. For receiving information on the operator of the application server, the application server AS may also comprise a keypad, or a touch screen, a microphone, or the like. Examples of said output means include a plug-in unit feeding information to the lines connected to its external connection points. For outputting information to the operator of the application server AS, they may also comprise a screen, a touch screen, a loudspeaker, or the like. The processing means 51, memory means 52, and interface block 53 are electrically interconnected for performing systematic execution of operations on the received and/or stored data according to the predefined, essentially programmed processes of the unit. In a solution according to the invention, the operations comprise a functionality for implementing the operations of the application server as described above.

The flow chart of FIG. 6 illustrates an example of the functionality of user equipment in view of the embodiment of the invention discussed in connection of FIG. 3. In initiation of the service, a user terminal of a subscriber of the service is provided with a terminal application, a service-specific browser that facilitates the use of the service. In step 61 the user terminal receives a browser related to the a service view (SV) of a news service. This browser is arranged to implement the terminal functionality to operate a news service discussed in connection with FIGS. 3 and 4. The browser may be delivered over the air in a message through the network. Naturally the service view may alternatively be configured through the application programming interfaces (API) of the user terminal. The browser related to the service view operates according to a structural definition of the service view, with which definition the user terminal is able to identify content elements received in a service package and output them appropriately, for example in the display of the user terminal. The service view may also comprise other definitions that control the implementation of the whole service.

In step 62 the user terminal checks whether a new service packet is imminent. In case the service is implemented as a push service, the availability of the new service packet may be detected at reception of a new delivered package. In case the service is implemented as a pull service, the availability of the new service packet may be detected, for example, at expiry of a timer that times the interval between consecutive downloads. The user terminal may alternatively receive a notification regarding availability of a new updated package in the application server. The user terminal may also receive from the user through the user interface of the terminal a command to furnish a new service package to the display of the user terminal. Within the scope of protection, there exists several possible ways of detecting and triggering procedures related to a new service package.

If a new service packet is imminent (step 63) the user terminal performs the necessary procedures for acquiring the service package (step 64). In case of push services, the new service package is already in the user terminal and it only needs to be retrieved for further processing. In case of pull services, the user terminal generates a request, send it to the application server, and in response receives the service package compiled by the application server, as disclosed earlier.

In step 65 the user terminal retrieves the structural definition of the service view, combines (step 66) it with the content items received in the service package and outputs (step 67) it in the prescribed format to the subscriber of the user terminal. The user receives all the relevant pages P1 . . . P6 of the service with only one over-the-air download procedure, and may thereafter browse the pages one by one, for example in the display window of the user terminal.

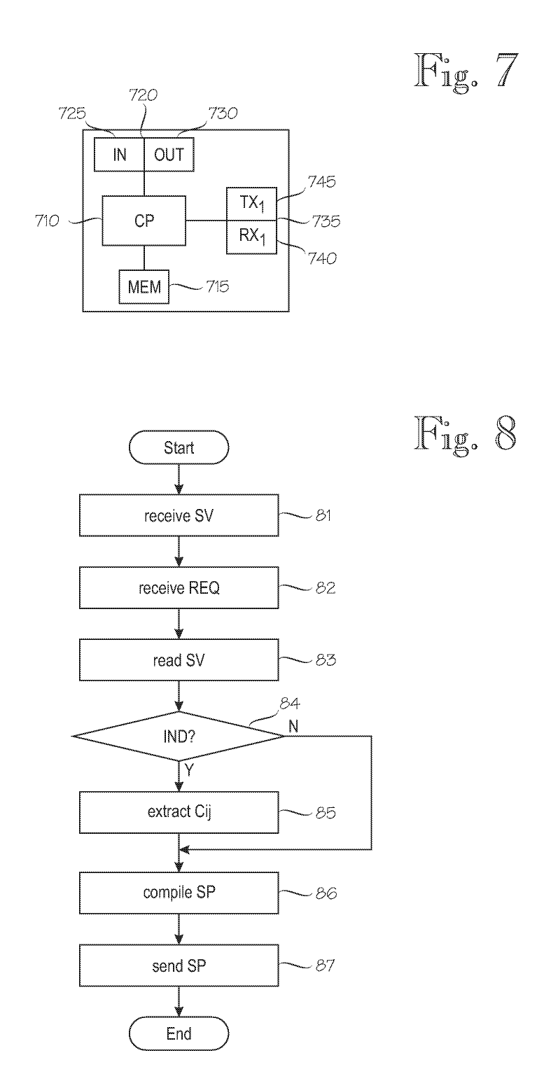

The implementation of the described mechanisms in the user equipment is illustrated by referring to FIG. 7 that comprises a functional description of user equipment UE. The user equipment UE comprises processing means 710, an element that comprises an arithmetic logic unit, a number of special registers and control circuits. Connected to the processing means are memory means 715, a data medium where computer-readable data or programs or user data can be stored. The memory means typically comprise memory units that allow both reading and writing (RAM), and a memory whose contents can only be read (ROM). The user equipment UE also comprises a user interface block 720 with input means 725 for inputting data by the user for internal processing in the unit, and output means 730 for outputting user data from the internal processes of the unit. Examples of said input means comprise a keypad, or a touch screen, a microphone, or the like. Examples of said output means comprise a screen, a touch screen, a loudspeaker, or the like. The user equipment UE also comprises a communication unit 735 configured with receiving means 740 for receiving information from the air interface and processing it for inputting to the processing means 710, as well as with transmitting means 745 for receiving information from the processing means 710, and further processing it for sending via the air interface. The implementation of such a communication unit is generally known to a person skilled in the art. The processing means 710, the memory means 715, the user interface block 720, and the communication unit 735 are electrically interconnected for performing systematic execution of operations on the received and/or stored data according to predefined, essentially programmed processes of the unit. In a solution according to the invention, the operations comprise the functionality of the user equipment UE as described above.

Another problem related to the distribution of information has been the inability to flexibly tailor the service according to the requirements of the receiving end, i.e. the subscriber of the service or the user terminal at hand.

For example, a user equipment UE can be a simplified terminal for speech only or it can be a terminal for diverse services acting as a service platform and supporting the loading and execution of various functions related to the services. When launching new systems, it has been noticed that the functionality sets and display features of different types of user equipment vary considerably, and therefore services cannot be provided uniformly but they need to be tailored separately for different types of terminals. Such need of tailoring has considerably slowed down the service implementations.

In order to overcome this problem, the content providers have provided separate downloadable pages for different types of user terminals. This has increased the amount of implementation work in the content provider side and thus reduced the profitability of the service. In the user side, the user has had to be aware of the configuration and version of his or her own user terminal and search the correct version of the pages for download. Users find such operations and requirements unpleasant and therefore even rather leave the service unused than take the time in adjusting the appropriate communication between his or her terminal and the application server.

On the other hand, in conventional websites or mobile sites the content provider provides a number of pages available for download, and the subscriber merely chooses whether to download the page or not. There is no way for the subscriber to in beforehand influence on the content that he or she wishes to download.

These problems are solved in a further embodiment of the present invention that allows sophisticated tailoring in the application service. This embodiment is illustrated by means of the flow chart of FIG. 8. The steps of the flow chart relate to the functionality of the application service in implementation of a pull type of news service already discussed in the context of FIG. 3. In step 81 the application server acting as a publication server receives information on a service view (SV) of a news service. In step 82 the application server also receives a request from a user terminal, requesting transmission of an updated service package. The application server reads (step 83) the service view comprising a definition for a group of content elements, where a content element is advantageously defined as an identification of a content elements and an address of the resource files where the data of the content element is available for the application server. In addition, the application server checks whether the request received from the user terminal comprises a tailoring indication. A tailoring indication herein refers to an information element included in the request, for example by means of a tag, a bit chart or structured data block. If such tailoring indication is found (step 84) in the request, the applications server interprets the indication and separates (step 85) from the group of the content items of the service view the content items according to the tailoring indication. After this the extracted content items are compiled (step 86), as discussed above, and sent (step 87) to the user terminal. If no tailoring indication is found (step 84) in the request, the procedure moves directly to the compilation step.

The illustrated embodiment is advantageous in that it provides means for practically eliminating the need for terminal dependent versions of one service view. The service-specific browser, in other words the terminal application in the user terminal may be arranged to detect a group of terminal capability details that are relevant from the point of view of the service. Detection of the terminal capability information is a standard functionality of mobile communication devices and its implementation through the device interfaces of user terminals is well known to a person skilled in the art. The detection may be arranged to take place, for example, during installation of the terminal application, when the terminal is switched on, and/or at defined intervals during the use of the terminal. When generating a request the terminal application includes automatically one or more indications that may be used in the application server for tailoring the content of the service package. Such indication may be, for example, indication of a limited memory, or inability to show colored pictures, or indication of a size of the display screen. After receiving the request, the application server may leave out defined content items, or content of whole pages that increase the size of the service package. As an advantage, the application server may thus generate a terminal-specific package where part of the content items originally listed in the service view are included or dropped out, depending on the characteristics of the content items and the capability of the terminal. For example, large content items or content items that comprise colored or wide pictures may be excluded. The content sources may provide the content items in one agreed form, the service provider may provide the service view in one agreed form and flexible terminal equipment—specific tailoring is still possible.

Additionally, the illustrated embodiment is advantageous in that it also provides means for dynamically tailoring the service according to the wishes of an individual service subscriber. The terminal application may be arranged to receive through the user interface of the user terminal an indication on the preferred content. Correspondingly, the content providers may be arranged to provide some of all content items with an attribute that may be matched with one or more of the indications. In such a case, the application server may be arranged to include in the service package only content items whose attributes correspond with the indication or indications included in the request by the user terminal. For example, the content items may be complement with an attribute that links them to a defined news category, like financial new, sports news, news alerts etc. The subscriber may then, at will, download only part of the news currently interesting to him or her. As another example, the content items may be complemented with an attribute that links them to a defined hierarchy level. The subscriber has then the liberty to download only part of the news whose hierarchy level exceeds the limit given in the request.

Furthermore, the illustrated embodiment is advantageous in that it also provides means for dynamically tailoring the service according to the position of the user. The terminal application may be arranged to receive an indication on the position of the user. Such indication may be, for example, automatically transferred from an integrated positioning device within the terminal equipment, it may be received from the network or input by the user through the user interface of the user terminal. Correspondingly, the content providers may be arranged to provide with some of all content items an attribute that may be matched with defined position information. In such a case, the application server may be arranged to include in the service package only content items whose attributes correspond with the position indication or indications included in the request by the user terminal. The subscriber may then be provide with, for example, only advertisements on entertainment occasions in the close proximity with his or her current location.

It should be noted that only some examples of the use of content attributes are discussed herein. The present invention encompasses a number of other implementations available for a person skilled in the art.

A further problem related to the conventional information distribution systems relates to charging when transfer of information is not free. When initiating a download of a single page by pressing the hyperlink the subscriber typically has no idea how much information the page contains. In case the page comprises a lot of content, its download requires massive data transmission that may be charged on a per byte basis. Typically the subscribers, who wish to be able to control the cost incurred by the use of service, dislike such situation. On the other hand, a monthly subscription is typically adjusted according to an averaged use, and may thus for some subscribers be too high and for some users too low. Optimally, charging based on usage would be preferred.

A further embodiment of the present invention solves this problem by an arrangement where the application server includes in the service package a script that causes the user terminal to generate and send a message to a defined address of the telecommunication system. A message to this address is arranged to generate a premium charge ticket that corresponds to a charge related to one individual download. For example, a content item of the first page of the service view may comprise a script that generates a character string and sends this character string as a text message to a defined separately charged MSISDN number. The advantage of the embodiment is that it provides a simple and easily realizable way such that the service may be charged according to the usage, i.e. the number of downloaded service packages. Additionally, dynamic adjustments to the charging strategies are made possible hereby.

It will be obvious to a person skilled in the art that, as the technology advances, the inventive concept can be implemented in various ways. For example, more than one service views may be defined for one service. Part of the pages may thus be linked to one service view and part of the pages to the other view such that different types of news may have a slightly different appearance. The invention and its embodiments are thus not limited to the examples described above but may vary within the scope of the claims.

1. A method of implementing an information distribution service in a communication system, said system comprising a server, a user equipment and an access network that enables exchange of information between the server and the user equipment, characterized by the method comprising:
creating at least one service view of an information distribution service, wherein the service view comprises one or more pages, a page being a separate output item comprising a combination of content data and page definition data such that the page definition data controls the format of the content data at outputting of the page;
configuring a server with editing means for collecting the content data of the one or more pages of each of the service views and packaging the content data of the one or more pages of a service view into a service package;
storing at least one page definition data of at least one service view in the user terminal, wherein the definition data is arranged to be combined with content data of the one or more pages of the service view;
configuring a user terminal with receiving means for receiving from the server the service package comprising the content data of the one or more pages of the service view to be combined with the at least one page definition data of the service view;
configuring the user terminal with output means for combining the at least one page definition data of the service view and the content data of the one or more pages in the service package and output the one or more pages of the service view at the user terminal.

2. A communication system, said system comprising a server, a user equipment and an access network that enables exchange of information between the server and the user equipment, characterized by the system comprising:
means for creating at least one service view of an information distribution service, wherein the service view comprises one or more pages, a page being a separate output item comprising a combination of content data and page definition data such that the page definition data controls the format of the content data at outputting of the page;
a server comprising editing means for collecting the content data of the one or more pages of each of the service views and packaging the content data of the one or more pages of a service view into a service package,
a user terminal comprising:
storing means for storing at least one page definition data of at least one service view, wherein the page definition data is configured to be combined with content data of the one or more pages of the service view;
receiving means for receiving from the server the service package comprising the content data of the one or more pages of the service view to be combined with the at least one page definition data of the service view;
output means for combining the at least one page definition data of the service view and the content data of the one or more pages in the service package and outputting the one or more pages of the service view.

3. A server comprising
access means for exchanging information with a user equipment through an access network; characterized by
communication means for receiving page definition on at least one service view of an information distribution service, wherein the service view comprises one or more pages, a page being a separate output item comprising a combination of content data and page definition data such that the page definition data controls the format of the content data at outputting of the page; and editing means for collecting the content data of the one or more pages of each of the service views and packaging the content data of the one or more pages of a service view into a service package.

4. A server according to claim 3, characterized by
receiving means for receiving a request for a service, adjusted to extract from the request a selection indication;
the editing means being arranged to:
determine an attribute attached to content items, and
package into the service package only the content items whose attribute matches the selection indication.

5. A server according to claim 4, characterized by the editing means being arranged to determine the attribute from a characteristic of the content item, said characteristic being related to a terminal capability requirement.

6. A server according to claim 4, characterized by the editing means being arranged to determine the attribute from a tag included in the content element.

7. A server according to claim 3, characterized by the editing means being arranged to include in the service package a script for initiating a receiving terminal to generate and transmit a message to a defined address of the telecommunication system.

8. A user terminal, comprising:
access means for accessing a server through an access network:
receiving definition on at least one service view of an information distribution service, wherein the service view comprises one or more pages, a page being a separate output item comprising a combination of content data and page definition data such that the page definition data controls the format of the content data at outputting of the page, characterized by
storing means for storing at least one page definition data of at least one service view in the user terminal, wherein the page definition data is configured to be combined with content data of the one or more pages of the service view;
receiving means for receiving from the server a service package comprising the content data of the one or more pages of the service view to be combined with the at least one page definition data of the service view;
output means for combining the at least one page definition data of the service view and the content data of the one or more pages in the service package and outputting the one or more pages of the service view.

9. A user terminal according to claim 8, characterized by
the receiving means comprising request means for initiating to the server a request for a service package comprising the content data of the one or more pages of the service view to be combined with the at least one page definition data of the service view.

10. A user terminal according to claim 9, characterized by the request means being arranged to include in a request a selection indication.

11. A user terminal according to claim 10, characterized by the indication being related to a required terminal capability.

12. A user terminal according to claim 10, characterized by the indication being related to the categorization of the content element.

13. A user terminal according to claim 12, characterized by the categorization being indicated as a number representing a hierarchical level of the content.

14. A user terminal according to claim 8, characterized by the receiving means being configured to receive in the service package a script; and
to generate and transmit a message to a defined address of the telecommunication system, in response to the received service package.

15. A method for managing information in a server of a communication system, characterized by the method comprising:
receiving a service view of an information distribution service, wherein the service view comprises one or more pages, a page being a separate output item comprising a combination of content data and page definition data such that the page definition data controls the format of the content data at outputting of the page;
collecting the content data of the one or more pages according to content data definitions in the service view and packaging the content data of the one or more pages of a service view into a service package.

16. Method for displaying information in a user terminal of a communication system, characterized by the method comprising:
receiving at least one service view of an information distribution service, wherein the service view comprises one or more pages, a page being a separate output item comprising a combination of content data and page definition data such that the page definition data controls the format of the content data at outputting of the page;
storing at least one page definition data of at least one service view, wherein the definition data is configured to be combined with content data of the one or more pages of the service view;
receiving from the server the service package comprising the content data of the one or more pages of the service view to be combined with the at least one page definition data of the service view;
combining the at least one page definition data of the service view and the content data of the one or more pages in the service package and output the one or more pages of the service view at the user terminal.

17. A computer program product, executable in a server, characterized in that execution of the computer program product in a server causes the server to perform the steps of the method of claim 15.

18. A computer program product, executable in a user terminal, characterized d in that execution of the computer program product in a server causes the server to perform the steps of the method of claim 16.
